(19) United States
(12) Patent Application Publication
(10) Pub. No.: US 2010/0309663 A1
(43) Pub. Date: Dec. 9, 2010

(54) LIGHTING FIXTURE WITH PLANAR-TYPE REFLECTING STRUCTURE

(75) Inventor: Ming-Hong LIAO, TAIPEI HSIEN (TW)

Correspondence Address: BRIAN M. MCINNIS, 12th Floor, Ruttonjee House, 11 Duddell Street, Hong Kong, HK

(73) Assignee: EIKO (PACIFIC) LTD., PORT LOUIS (MU)

(21) Appl. No.: 12/546,694

(22) Filed: Aug. 25, 2009

(30) Foreign Application Priority Data
Jun. 5, 2009 (TW) 98118814

(51) Int. Cl. F21V 7/00

(52) U.S. Cl. 362/235

(57) ABSTRACT

A lighting fixture includes a bottom frame having an inner bottom face and a first opening corresponding to the inner bottom face; a planar reflecting plate laid on the inner bottom face of the bottom frame; a plurality of lighting units mounted on the inner bottom face within the bottom frame to locate on the planar reflecting plate; a light diffusion sheet laid atop the bottom frame to cover the first opening; and a top frame configured corresponding to the bottom frame and defining a second opening corresponding to the first opening. The top frame is assembled to the bottom frame with the light diffusion sheet clamped therebetween to thereby close the second opening of the top frame. The planar reflecting plate allows the lighting fixture to be low-profile, and the light diffusion sheet uniformly distributes the light produced by the lighting units while eliminates glares and blocks off dust.

### RELATED APPLICATIONS

This application claims priority to Taiwan Application Serial Number 98118814, filed Jun. 5, 2009, which is herein incorporated by reference.

### FIELD OF THE INVENTION

The present invention relates to a lighting fixture, and more particularly to a lighting fixture with planar-type reflecting structure.

### BACKGROUND OF THE INVENTION

A conventional lighting fixture, such as a fluorescent lighting fixture, usually includes a plurality of tubular lamps mounted in a frame to produce light for illumination. For the produced light to effectively project outward, the frame of the lighting fixture is usually provided on an inner side with reflection plates for reflecting the light outward.

In the conventional lighting fixture, the reflection plates are usually mounted to two opposite sides of the lamps. The conventional reflection plates require a lot of time and labor to install them, and would increase an overall thickness of the lighting fixture and are therefore not suitable for realizing the requirement of low-profile design. Further, most of the available lamps would produce glares, and the conventional lighting fixture does not include any structure to eliminate the glares. Frequently, the conventional lighting fixture is not provided with a cover and is subject to invasion by dust, insects and particles, resulting in dirty lamps and reduced lighting effect of the lighting fixture.

### SUMMARY OF THE INVENTION

A primary object of the present invention is to provide a lighting fixture with planar-type reflecting structure, so that the lighting fixture is low-profile, glare-free and dust-proof.

To achieve the above and other objects, the lighting fixture with planar-type reflecting structure according to an embodiment of the present invention includes a bottom frame having at least one inner bottom face and defining at least one first opening corresponding to the at least one inner bottom face; at least one planar reflecting plate laid on the inner bottom face of the bottom frame; a plurality of lighting units mounted to and spaced on the inner bottom face within the bottom frame to locate on a surface of the planar reflecting plate; at least one light diffusion sheet laid atop the bottom frame to cover the first opening; and a top frame configured corresponding to the bottom frame and defining at least one second opening corresponding to the first opening of the bottom frame. The top frame is assembled to the bottom frame from one side of the bottom frame with the first opening, such that the light diffusion sheet is clamped between the top frame and the bottom frame to thereby close the second opening of the top frame. The planar reflecting plate allows the lighting fixture to be low-profile, and the light diffusion sheet uniformly distributes the light produced by the lighting units while eliminates glares and blocks off dust.

According to a further embodiment of the present invention, the bottom frame has a first inner bottom face and a second inner bottom face, which are joined with an angle container therebetween, so that the lighting units mounted thereon project light in different directions, and a multi-directional illuminating effect can be achieved.

According to a further embodiment of the present invention, the lighting fixture further includes a brightness enhancement film, which can be located on either a lower side or an tipper side of the light diffusion sheet for enhancing the brightness of the light produced by the lighting units.

According to a further embodiment of the present invention, the planar reflecting plate is provided with a plurality of spaced and upward tapered ridges or curve-topped ridges. Each of the tapered or curve-topped ridges has two back-to-back slant faces or a curved top face, respectively, which are separately oriented to the plurality of lighting units and can therefore provide multiple planes for reflecting the light produced by the lighting units and achieve good light reflection effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a lighting fixture with planar-type reflecting structure implemented according to a first embodiment of the present invention;

FIG. 2 is an assembled sectional view of the lighting fixture of FIG. 1;

FIG. 3 is an exploded perspective view of a lighting fixture with planar-type reflecting structure implemented according to a second embodiment of the present invention;

FIG. 4 is an exploded perspective view of a lighting fixture with planar-type reflecting structure implemented according to a third embodiment of the present invention;

FIG. 5 is an assembled sectional view of a lighting fixture with planar-type reflecting structure implemented according to a fourth embodiment of the present invention, in which a brightness enhancement film is further included;

FIG. 6 is an assembled sectional view of a lighting fixture with planar-type reflecting structure implemented according to a fifth embodiment of the present invention, in which a planar reflecting plate with a plurality of spaced and upward tapered ridges is included;

FIG. 7 is an assembled sectional view of a lighting fixture with planar-type reflecting structure implemented according to a sixth embodiment of the present invention, in which a planar reflecting plate with a plurality of spaced, upward tapered and flat-topped ridges is included; and

FIG. 8 is an assembled sectional view of a lighting fixture with planar-type reflecting structure implemented according to a seventh embodiment of the present invention, in which a planar reflecting plate with a plurality of spaced and curve-topped ridges is included.

### DETAILED DESCRIPTION OF THE PREFERRED EMBODIMENTS

The present invention will now be described with some preferred embodiments thereof. For the purpose of easy to understand, elements that are the same in the preferred embodiments are denoted by the same reference numerals.

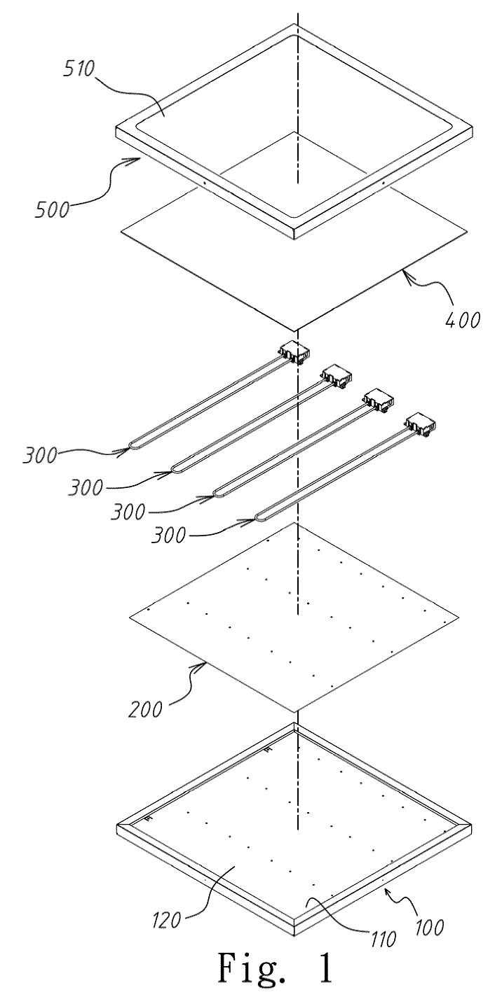

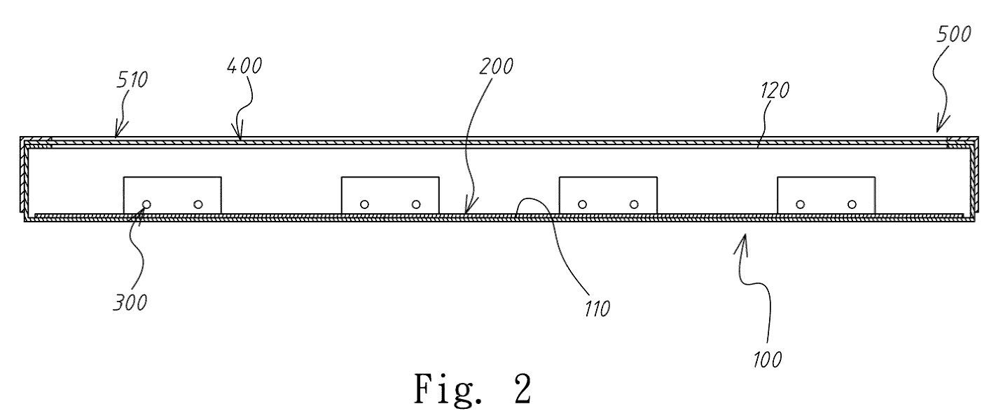

Please refer to FIGS. 1 and 2 that are exploded perspective view and assembled sectional view, respectively, of a lighting fixture with planar-type reflecting structure implemented according to a first embodiment of the present invention. For the purpose of conciseness, the present invention will also be briefly referred to as “the lighting fixture” herein. As shown, the lighting fixture in the first embodiment includes a bottom frame 100, a planar reflecting plate 200, a plurality of lighting units 300, a light diffusion sheet 400, and a top frame 500.

The bottom frame 100 has,an inner bottom face 110 and defines a first opening 120 opposite and corresponding to the inner bottom face 110.

The planar reflecting plate 200 is flatly laid on the inner bottom face 110 of the bottom frame 100 for reflecting light produced by the lighting units 300. Herein, one side of the planar reflecting plate 200 facing away from the inner bottom face 110 is defined as a surface of the planar reflecting plate 200.

The plurality of lighting units 300 are fixedly mounted to the inner bottom face 110 to locate on the surface of the planar reflecting plate 200 within the bottom frame 100. The lighting units 300 are not restricted to any particular type, and can be, for example, fluorescent tubes or light-emitting diodes (LEDs). In the case of fluorescent lamps, the lighting units 300 can be cold cathode fluorescent lamps (CCFLs) or hot cathode fluorescent lamps (HCFLs).

The light diffusion sheet 400 is laid atop the bottom frame 100 to cover the first opening 120 for uniformly distributing the light produced by the lighting units 300 and eliminating glares of the lighting units 300, such as fluorescent lamps.

The top frame 500 is configured and sized corresponding to the bottom frame 100 and defines a second opening 510, which corresponds to the first opening 120 of the bottom frame 100. The top frame 500 is assembled to the bottom frame 100 from one side of the bottom frame 100 with the first opening 120, such that the light diffusion sheet 400 is clamped between the top frame 500 and the bottom frame 100 to thereby close the second opening 510 of the top frame 500.

According to the present invention implemented in the above form, the light produced by the lighting units 300 is completely reflected by the planar reflecting plate 200 to effectively project outward. The outward projected light is diffused by the light diffusion sheet 400 to become uniformly distributed, so that glares produced by the lighting units 300 are eliminated. Meanwhile, with the second opening 510 of the top frame 500 being closed by the light diffusion sheet 400, the light diffusion sheet 400 also functions like a dust cover to prevent external dust, insects and other particles from invading into the lighting fixture.

Further, the present invention implemented in the above form adopts a planar-type reflecting structure, that is, the planar reflecting plate 200, which is laid on the inner bottom face 110 of the bottom frame 100. The planar-type reflecting structure can be more conveniently assembled to the lighting fixture and can advantageously reduce an overall thickness of the lighting fixture to meet the requirement for a low-profile design.

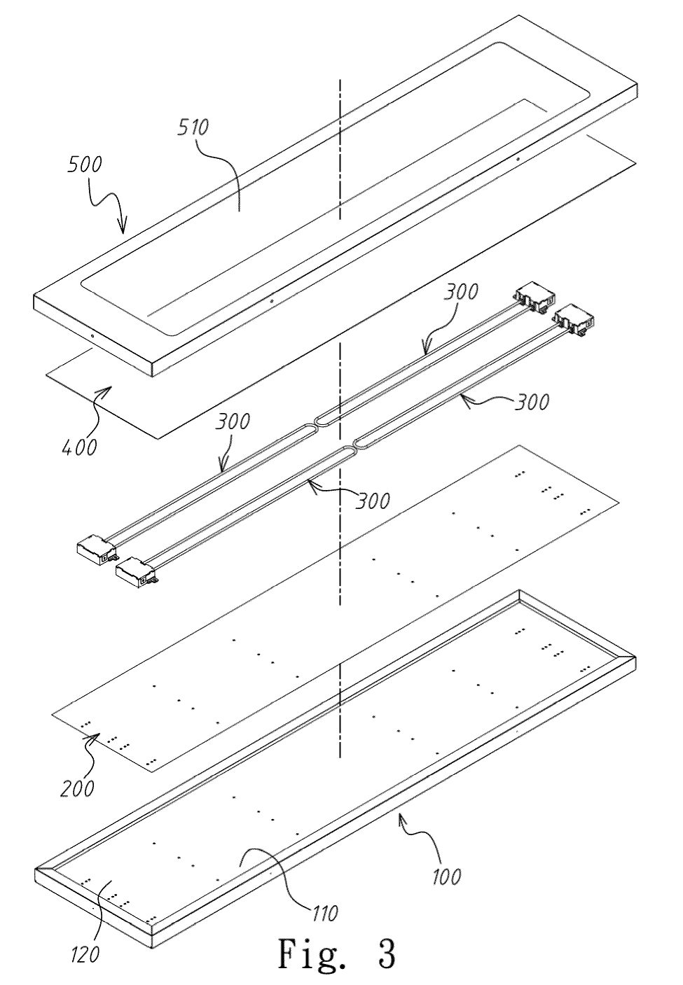

In the present invention, the lighting fixture is not restricted to any particular geometrical shape. For example, the lighting fixture of the present invention can have a square shape as in the first embodiment shown in FIGS. 1 and 2, or a rectangular shape as in a second embodiment shown in FIG. 3.

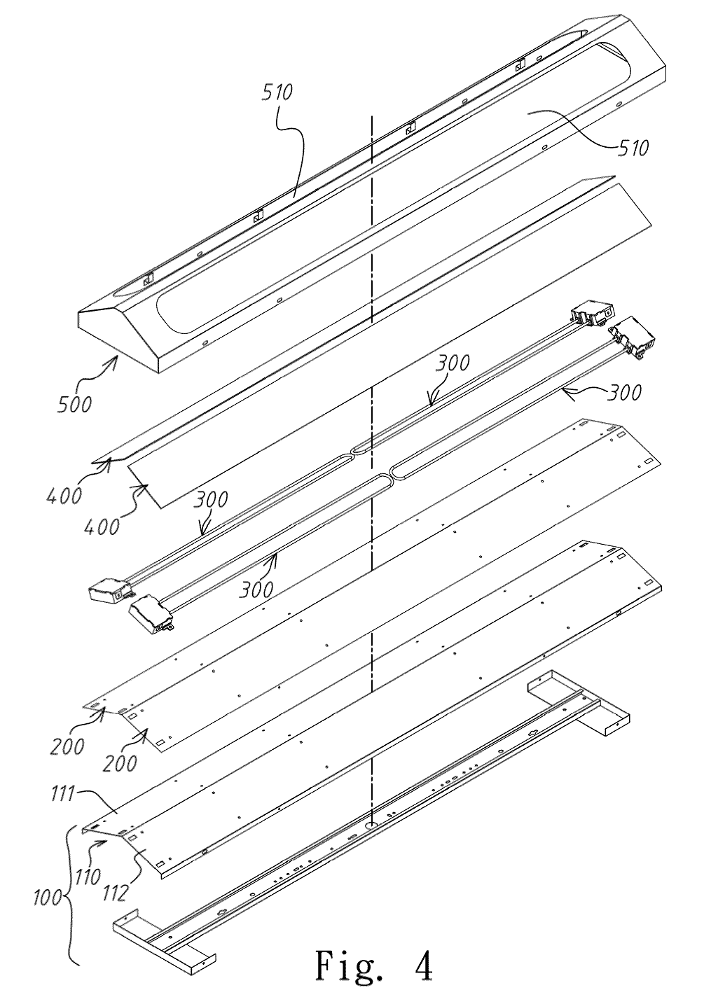

The bottom frame 100 of the lighting fixture is not restricted to have only one inner bottom face 110. For example, in a lighting fixture according to a third embodiment of the present invention as shown in FIG. 4, the bottom frame 100 thereof has two inner bottom faces 110, namely, a first inner bottom face 111 and a second inner bottom face 112, which are joined with an angle contained therebetween.

Meanwhile, in the third embodiment, there are two light diffusion sheets 400 and the top frame 500 is provided with two second openings 510 to correspond to the first and the second inner bottom face 111, 112. With the above arrangements, the first and the second inner bottom face 111, 112 of the bottom frame 100 are oriented toward different directions, bringing the lighting units 300 mounted thereon to project light in different directions. Therefore, a multi-directional illuminating effect can be achieved with the present invention.

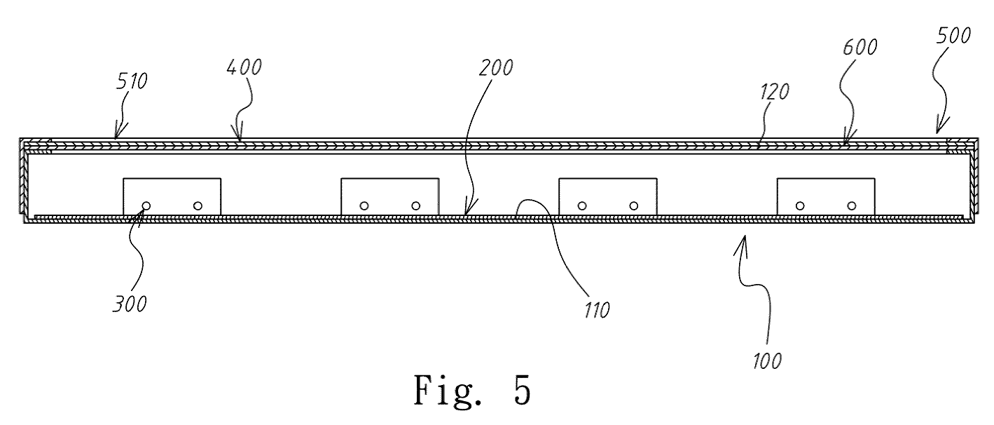

FIG. 5 is an assembled sectional view of a lighting fixture with planar-type reflecting structure according to a fourth embodiment of the present invention. In the fourth embodiment, the lighting fixture further includes a brightness enhancement film 600, which is located on a lower side of the light diffusion sheet 400 for enhancing the brightness of the light produced by the lighting units 300. The brightness enhancement film 600 can be otherwise located on an upper side of the light diffusion sheet 400 to provide the same brightness enhancing effect.

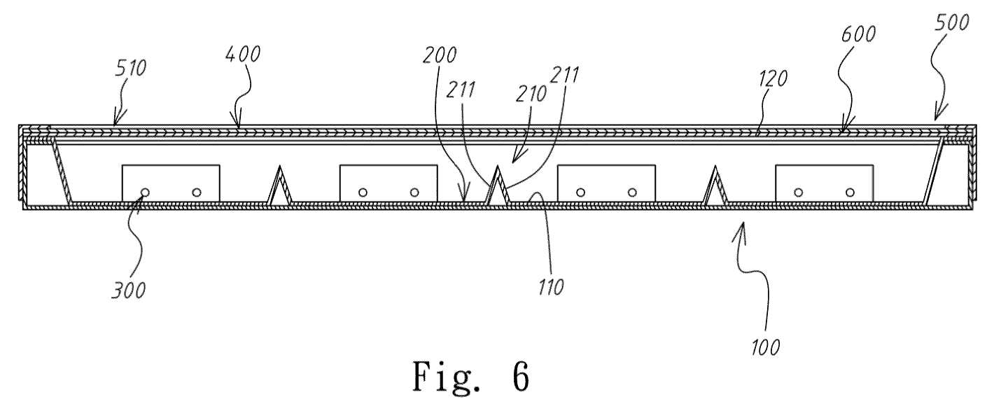

FIG. 6 is an assembled sectional view of a lighting fixture with planar-type reflecting structure according to a fifth embodiment of the present invention. In the fifth embodiment, the lighting fixture includes a planar reflecting plate 200 being provided with a plurality of spaced and upward tapered ridges 210. Each of the tapered ridges 210 has two back-to-back slant faces 211, which are separately oriented to the plurality of lighting units 300 and can therefore provide multiple planes for reflecting the light produced by the lighting units 300 and achieve good reflection effect. The tapered ridges 210 each have a height lower than that of the bottom frame 100, and accordingly, do not have any adverse influence on the requirement for low-profile design of the lighting fixture.

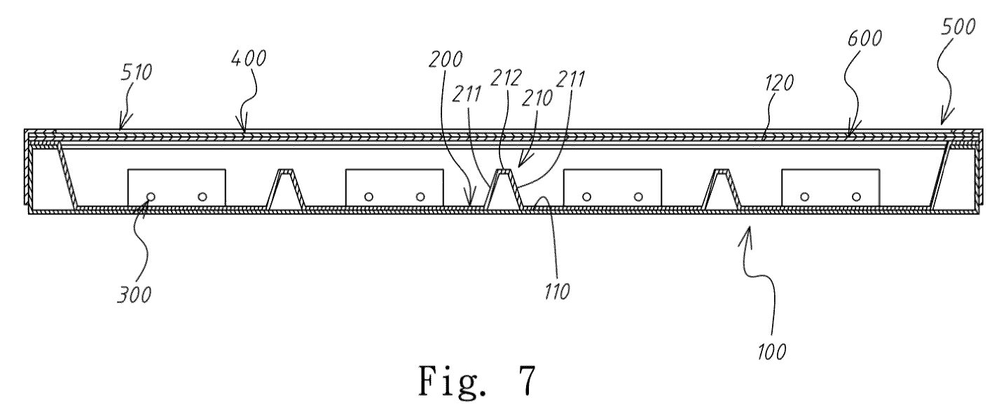

FIG. 7 is an assembled sectional view of a lighting fixture with planar-type reflecting structure according to a sixth embodiment of the present invention. The sixth embodiment has a structural design based on the fifth embodiment, except that the plurality of tapered ridges 210 each have a flat top 212 to provide more reflection planes than the fifth embodiment. Therefore, the light produced by the lighting units 300 can be reflected from more planes to obtain even better reflection effect.

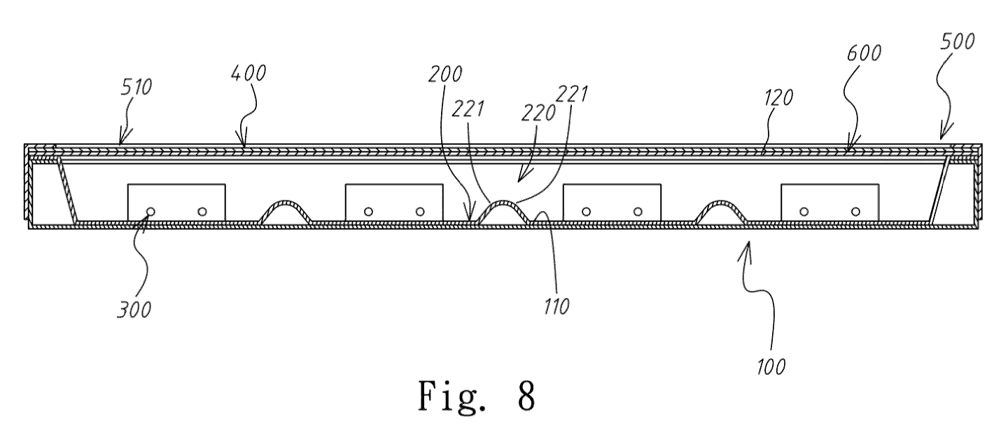

FIG. 8 is an assembled sectional view of a lighting fixture with planar-type reflecting structure according to a seventh embodiment of the present invention. In the seventh embodiment, the lighting fixture includes a planar reflecting plate 200 being provided with a plurality of spaced and curve-topped ridges 220. Each of the curve-topped ridges 220 has a curved top face 221, and the curved top faces 221 are separately oriented to the plurality of lighting units 300 and can therefore reflect the light produced by the lighting units 300 to different angular directions and provide good light reflection effect. The curve-topped ridges 220 each have a height lower than that of the bottom frame 100 and accordingly, do not have any adverse influence on the requirement for low-profile design of the lighting fixture.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A lighting fixture with planar-type reflecting structure, comprising:
a bottom frame having at least one inner bottom face and defining at least one first opening opposite and corresponding to the at least one inner bottom face;
at least one planar reflecting plate being laid on the at least one inner bottom face of the bottom frame, and one side of the planar reflecting plate facing away from the inner bottom face is a surface of the planar reflecting plate;
a plurality of lighting units being fixedly mounted to and spaced on the at least one inner bottom face within the bottom frame to locate on the surface of the at least one planar reflecting plate;
at least one light diffusion sheet being laid atop the bottom frame to cover the at least one first opening of the bottom frame; and
a top frame being configured and sized corresponding to the bottom frame and defining at least one second opening, which corresponds to the at least one first opening of the bottom frame; the top frame being assembled to the bottom frame from one side of the bottom frame with the first opening, such that the at least one light diffusion sheet is clamped between the top frame and the bottom frame to thereby close the at least one second opening of the top frame.

2. The lighting fixture with planar-type reflecting structure as claimed in claim 1, wherein the bottom frame has a first and a second inner bottom face, and the first and the second inner bottom face are joined with an angle contained therebetween.

3. The lighting fixture with planar-type reflecting structure as claimed in claim 1, wherein the lighting units are fluorescent lamps.

4. The lighting fixture with planar-type reflecting structure as claimed in claim 3, wherein the fluorescent lamps are cold cathode fluorescent lamps.

5. The lighting fixture with planar-type reflecting structure as claimed in claim 3, wherein the fluorescent lamps are hot cathode fluorescent lamps.

6. The lighting fixture with planar-type reflecting structure as claimed in claim 1, wherein the lighting units are light-emitting diodes (LEDs).

7. The lighting fixture with planar-type reflecting structure as claimed in claim 1, further comprising a brightness enhancement film being located on either a lower side or an upper side of the light diffusion sheet.

8. The lighting fixture with planar-type reflecting structure as claimed in claim 1, wherein the planar reflecting plate is provided with a plurality of spaced and upward tapered ridges, each of the tapered ridges having two back-to-back slant faces separately oriented toward the plurality of lighting units.

9. The lighting fixture with planar-type reflecting structure as claimed in claim 7, wherein the planar reflecting plate is provided with a plurality of spaced and upward tapered ridges, each of the tapered ridges having two back-to-back slant faces separately oriented toward the plurality of lighting units.

10. The lighting fixture with planar-type reflecting structure as claimed in claim 8, wherein the tapered ridges each have a flat top.

11. The lighting fixture with planar-type reflecting structure as claimed in claim 9, wherein the tapered ridges each have a flat top.

12. The lighting fixture with planar-type reflecting structure as claimed in claim 1, wherein the planar reflecting plate is provided with a plurality of spaced and upward curve-topped ridges, each of the curve-topped ridges having a curved top face, and the curved top faces being separately oriented toward the plurality of lighting units.

13. The lighting fixture with planar-type reflecting structure as claimed in claim 7, wherein the planar reflecting plate is provided with a plurality of spaced and upward curve-topped ridges, each of the curve-topped ridges having a curved top face, and the curved top faces being separately oriented toward the plurality of lighting units.
